(19) United States
(12) Patent Application Publication
(10) Pub. No.: US 2012/0318449 A1
(43) Pub. Date: Dec. 20, 2012

(54) METHOD FOR MAKING A SPONGE RUBBER OF A TABLE TENNIS RACKET

(76) Inventor: Kuang Tsu Li, Hong Kong (CN)

(21) Appl. No.: 13/163,670

(22) Filed: Jun. 17, 2011

(51) Int. Cl. B32B 38/04

(52) U.S. Cl. 156/256

(57) ABSTRACT

A method for making a sponge rubber of a table tennis racket contains mixing at least two prescriptions together to form at least two mixed rubbers; rolling the at least two mixed rubbers on at least two rolling machines respectively to roll the mixed rubbers into at least two laminated prefabrications; piling at least two prefabrications together to eliminate air between the prefabrications so that the prefabrications contact with each other tightly; cutting a piled prefabrication into a plurality of units with a proper size; vulcanizing a cut prefabrication in a mold to obtain a single-layer sponge rubber.

### BACKGROUND OF THE INVENTION

1. Field of the Invention

The present invention relates to a method for making a sponge rubber of a table tennis racket.

2. Description of the Prior Art

Conventional table tennis racket includes a substrate having one or a plurality of layer of sponge rubber attached on one side thereof, and an outwardmost layer of sponge rubber is attached with a protective film. If between the substrate and the protective film is defined a single sponge rubber, an elasticity is poor.

CN Pat. No. 200520066441.8 discloses a table tennis racket includes a substrate and a protective film between which a multi-layer sponge rubbers with the same or different elasticity are defined, wherein different sponge rubbers are vulcanized and adhered by using an adhesive, accordingly the layer of the sponge rubbers are provided based on requirement and different sponge rubbers are made according to different prescriptions. However, such a sponge rubber will generate a hard film and the sponge rubber is removed easily to lower elasticity of the table tennis racket.

The present invention has arisen to mitigate and/or obviate the afore-described disadvantages.

### SUMMARY OF THE INVENTION

The primary object of the present invention is to provide a method for making a sponge rubber of a table tennis racket that is capable of overcoming the shortcomings of the conventional method for making the sponge rubber of the table tennis racket.

Further object of the present invention is to provide a method for making a sponge rubber of a table tennis racket that is capable of prevent from generating a hard film and a removable layer after piling and connecting different mixed rubbers together.

Another Further object of the present invention is to provide a method for making a sponge rubber of a table tennis racket that is capable of making customized sponge rubber based on different requirements.

A method for making a sponge rubber of a table tennis racket in accordance with the present invention comprises:
mixing at least two prescriptions together to form at least two mixed rubbers;
rolling the at least two mixed rubbers on at least two rolling machines respectively to roll the mixed rubbers into at least two laminated prefabrications;
piling at least two prefabrications together to eliminate air between the prefabrications so that the prefabrications contact with each other tightly;
cutting a piled prefabrication into a plurality of units with a proper size;
vulcanizing a cut prefabrication in a mold to obtain a single-layer sponge rubber.

### BRIEF DESCRIPTION OF THE DRAWINGS

FIG. 1 is a diagram showing the production of a sponge rubber of a table tennis racket in accordance with a preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

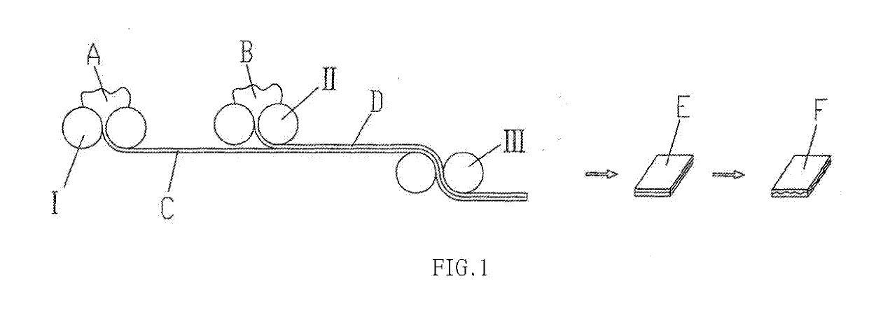

As shown in FIG. 1, a method for making a sponge rubber of a table tennis racket according to a preferred embodiment of the present invention comprises
making prescription #1, wherein a natural rubber 100, a polybutadiene rubber 20, a stearic acid 2, a zinc oxide 5, a vulcanization accelerator CZ 1.3, M 0.4, and D 0.2, a foaming agent H 3, a foaming agent AC 2, a transparent white carbon black 20, an engine oil 6, a sulfur 2.5, and a coloring agent 0.2 are mixed together to obtain a mixed rubber A with 30° hardness;
making prescription #2, wherein a natural rubber 100, a polybutadiene rubber 20, a stearic acid 2, a zinc oxide 5, a vulcanization accelerator CZ 1.3, M 0.4, and D 0.2, a foaming agent H 4, a foaming agent AC 2, a transparent white carbon black 30, an engine oil 6, a sulfur 3.0, and a coloring agent 0.2 are mixed together to obtain a mixed rubber B with 40° hardness;

The mixed rubber A and the mixed rubber B are feed onto a first rolling machine I and a second rolling machine respectively so that the mixed rubber A and the mixed rubber B are rolled into a first laminated prefabrication C and a second laminated prefabrication D; the first laminated prefabrication C and the second laminated prefabrication D are piled together and pressed together by a third rolling machine III to eliminate air and to contact the first laminated prefabrication C and the second laminated prefabrication D tightly; thereafter the pressed first prefabrication C and the pressed second laminated prefabrication D are cut into a plurality of units E in a proper size, the unit E are put in a sponge mold to be vulcanized, thereby obtaining a single-layer sponge rubber F.

Thereby, the single-layer sponge rubber F are manufactured by using two mixed rubbers to achieve different elasticities.

It is to be noted that when a quantity of the mixed rubbers is more than 2, i.e., every additionally mixed rubber is piled, pressed, and vulcanized by each added rolling machine. Two adjacent prefabrications are made by different prescriptions, and two separated prefabrications are made by the same prescription. Thickness of the prefabrications are the same or different.

While we have shown and described various embodiments in accordance with the present invention, it is clear to those skilled in the art that further embodiments may be made without departing from the scope of the present invention.

What is claimed is:

1. A method for making a sponge rubber of a table tennis racket comprising:
mixing at least two prescriptions together to form at least two mixed rubbers;
rolling the at least two mixed rubbers on at least two rolling machines respectively to roll the mixed rubbers into at least two laminated prefabrications;
piling at least two prefabrications together to eliminate air between the prefabrications so that the prefabrications contact with each other tightly;
cutting a piled prefabrication into a plurality of units with a proper size;
vulcanizing a cut prefabrication in a mold to obtain a single-layer sponge rubber.

2. The method for making the sponge rubber of the table tennis racket as claimed in claim 1, wherein two adjacent prefabrications are made by different prescriptions, and two separated prefabrications are made by the same prescription in a piling process.

3. The method for making the sponge rubber of the table tennis racket as claimed in claim 1, wherein thicknesses of the prefabrications are the same.

4. The method for making the sponge rubber of the table tennis racket as claimed in claim 1, wherein thicknesses of the prefabrications are different.

5. The method for making the sponge rubber of the table tennis racket as claimed in claim 1, wherein after the at least two prefabrications are piled together, they are pressed together by another rolling machine.
